(19) United States
(12) Patent Application Publication
(10) Pub. No.: US 2007/0216604 A1
(43) Pub. Date: Sep. 20, 2007

(54) Plasma display apparatus

(76) Inventors: Tae Hyung Kim, Seoul (KR); Jong Woon Kwak, Anyang-si (KR); Woong Kee Min, Yongin-si (KR); Byung Goo Kong, Seoul (KR); Seong Hak Moon, Seoul (KR); Oe dong Kim, Seongnam-si (KR)

Correspondence Address: KED & ASSOCIATES, LLP, P.O. Box 221200, Chantilly, VA, 20153-1200, US

(21) Appl. No.: 11/717,777

(22) Filed: Mar. 14, 2007

(30) Foreign Application Priority Data
Mar. 14, 2006 (KR) 10-2006-0023589
Mar. 26, 2006 (KR) 10-2006-0047834

(51) Int. Cl. G09G 3/28

(52) U.S. Cl. 345/60

(57) ABSTRACT

A method of driving a plasma display apparatus is provided. In the method, a positive first pulse and a negative second pulse are alternatively supplied to a first electrode in a sustain period. A second electrode sustains a ground level in a second electrode while the positive first pulse is supplied to the first electrode. Then, the absolute voltage values of the positive first pulse and the negative second pulse are controlled to be different.

This nonprovisional application claims priority under 35 U.S.C. §119(a) on Patent Application Nos. 10-2006-0023589 and 10-2006-0047834 filed in Republic of Korea on Mar. 14, 2006 and May 26, 2006, the entire contents of which are hereby incorporated by reference.

### BACKGROUND

1. Field

This document relates to a method of driving a plasma display apparatus.

2. Related Art

In general, a plasma display apparatus comprises a plasma display panel for displaying images and a driver disposed at the rear surface of the plasma display panel for driving the plasma display panel.

The plasma display panel comprises an upper substrate, a lower substrate separated from the upper substrate at a predetermined distance, and a barrier rib formed between the upper substrate and the lower substrate for forming a plurality of discharging cells. Each cell is charged with a discharge gas such as neon (Ne), helium (He), or a mixture (Ne+He) of neon and helium, and Inert gas containing a small quantity of xenon (Xe). A pixel is formed of the discharge cells, a red discharge cell R, a green discharge cell G, and a blue discharge cell.

When a discharge is induced using a high frequency pulse, the inert gas generates vacuum ultraviolet rays and excites phosphors between the barrier ribs, thereby embodying images.

The plasma display panel comprises a plurality of electrodes, for example, scan electrodes Y, sustain electrodes Z, and address electrodes X. The electrodes are connected to corresponding drivers for supplying a driving voltage to the electrodes of the plasma display panel.

While the plasma display panel is driving, each of the drivers supplies a corresponding driving pulse to the electrodes of the plasma display panel at a predetermined period to excite the discharge cells. For example, the drivers supplies a reset pulse, a scan pulse, and a sustain pulse at a reset period, an address period, and a sustain period.

The plasma display apparatus is attracting attention as a display apparatus due to its slimness and lightweightness.

### SUMMARY

An aspect of this document is to provide a method of driving a plasma display apparatus for reducing brightness difference between electrode lines while a plasma display panel is driving.

Another aspect of this document is to provide a method of driving a plasma display apparatus for driving a plasma display panel with low cost.

Still another aspect of this document is to provide a method of driving a plasma display apparatus for embodying stable sustain discharge when a plasma display panel is driving.

In an aspect, a method of driving a plasma display apparatus by dividing one subfield into at least an address period and a sustain period is provided. In the method, a positive first pulse and a negative second pulse are alternatively supplied to a first electrode in a sustain period. Then, a ground level is sustained at a second electrode while the positive first pulse is supplied to the first electrode. The absolute voltage values of the positive first pulse and the negative second pulse are controlled to be different.

Implementations may include one or more of the following features. For example, a first positive pulse may be supplied to a second electrode while a negative second pulse is supplied to a first electrode in the sustain period.

In another aspect, a method of driving a plasma display apparatus by dividing one subfield into at least an address period and a sustain period is provided. In the method, a first positive pulse and a second negative pulse having an absolute voltage value smaller than that of the first pulse are alternatively supplied in the sustain period. Then, the first positive pulse is supplied to a second electrode while the second pulse is supplied to the first electrode. A second positive pulse is supplied to a third electrode while the first pulse is supplied to the first electrode.

In still another aspect, a method of driving a plasma display apparatus by dividing one subfield into at least an address period and a sustain period is provided. In the method, a positive first pulse and a negative second pulse having the same absolute voltage value are alternatively supplied to a first electrode in the sustain period. Then, a negative third pulse is supplied to a second electrode while the positive first pulse is supplied to the first electrode.

It is to be understood that both the foregoing general description and the following detailed description are exemplary and explanatory and are intended to provide further explanation of the invention as claimed.

### BRIEF DESCRIPTION OF THE DRAWINGS

The implementation of this document will be described in detail with reference to the following drawings in which like numerals refer to like elements.

FIG. 1 is a schematic diagram illustrating a plasma display device according to an embodiment of the present invention;

FIG. 2 is a timing diagram illustrating a driving waveform supplied to a plasma display panel according to an embodiment of the present invention;

FIG. 3 is a timing diagram illustrating a driving pulse supplied to scan electrodes and sustain electrodes in a sustain period of FIG. 2 according to a first embodiment of the present invention;

FIG. 4 is a timing diagram illustrating a driving pulse supplied to scan electrodes and sustain electrodes in a sustain period of FIG. 2 according to the second embodiment of the present invention;

FIG. 5 is a timing diagram illustrating a driving pulse supplied to scan electrode and sustain electrodes in a sustain period of FIG. 2 according to the third embodiment of the present invention;

FIG. 6 is a schematic diagram illustrating a plasma display apparatus according to another embodiment of the present invention;

FIG. 7 is a timing diagram illustrating a driving waveform supplied to a plasma display panel according to another embodiment of the present invention;

FIG. 8 is a timing diagram illustrating a driving waveform supplied to a plasma display panel according to another embodiment of the present invention; and

FIG. 9 is a timing diagram illustrating a driving waveform supplied to a plasma display panel according to still another embodiment of the present invention.

### DETAILED DESCRIPTION

Hereinafter, an implementation of this document will be described in detail with reference to the attached drawings.

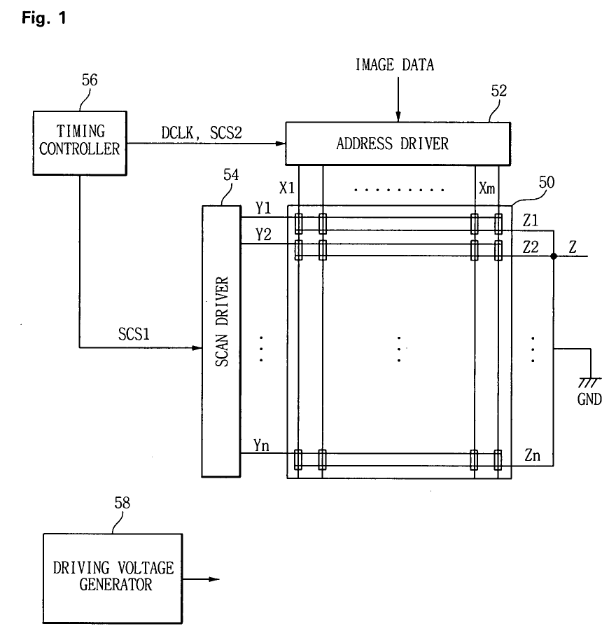

FIG. 1 is a schematic diagram illustrating a plasma display device according to an embodiment of the present invention.

Referring to FIG. 1, the plasma display apparatus according to the present embodiment comprises a plasma display panel 50, an address driver 52, a scan driver 54, a timing controller 56, and a driving voltage generator 58.

The plasma display panel 50 comprises a plurality of first electrode Y1 to Yn, and a plurality of second electrode Z1 to Zn, which are arranged in a column direction, and a plurality of third electrodes X1 to Xn arranged in a row direction. The first electrodes Y1 to Yn denote scan electrodes, the second electrode Z1 to Zn denotes sustain electrodes, and the third electrode X1 to Xm denote address electrodes, hereinafter.

The address driver 52 is controlled by a data clock DCLK and a second switching control signal SCS2 outputted from the timing controller 56 and supplies image data from an external device to the address electrodes X1 to Xm.

The scan driver 54 supplies a reset pulse and a scan pulse to the scan electrodes Y1 to Ym according to the first switching control signal SCS1 supplied from the timing controller 56. The scan driver 54 alternatively supplies a positive sustain pulse as a first pulse and a negative sustain pulse as a second pulse to the scan electrodes Y1 to Ym in order to induce a sustain discharge with the sustain electrodes Z1 to Zn that always receive bias voltage, preferably, a ground voltage GND.

The sustain electrodes Z1 to Zn disposed at the plasma display panel 50 are connected to a ground voltage source GND. That is, the plasma display panel 50 does not comprise a driver for driving the sustain electrodes. Therefore, the manufacturing cost of the plasma display apparatus can be reduced. The plasma display apparatus surely comprise a driver for driving the sustain electrodes for supplying a predetermined bias voltage to the sustain electrode or control the sustain electrodes to sustain the ground voltage.

The driving voltage generator 58 generates various driving voltages to generate a predetermined driving waveform, and supplies the generated driving voltage to the address driver 52 and the scan driver 54.

The timing controller 56 generates various switching control signals for generating a predetermined driving waveform and supplies the generated switching control signals to the address driver 52 and the scan driver 54. For example, the timing controller 56 generates a first switching signal SCS1 and supplies the generated first switching signal to the scan driver 54. The timing controller 56 generates the second control signal SCS2 and the data clock DCLK and supplies the second control signal SCS2 and the data clock DCLK to the address driver 52.

Hereinafter, a method of driving a plasma display apparatus according to an embodiment of the present invention will be described.

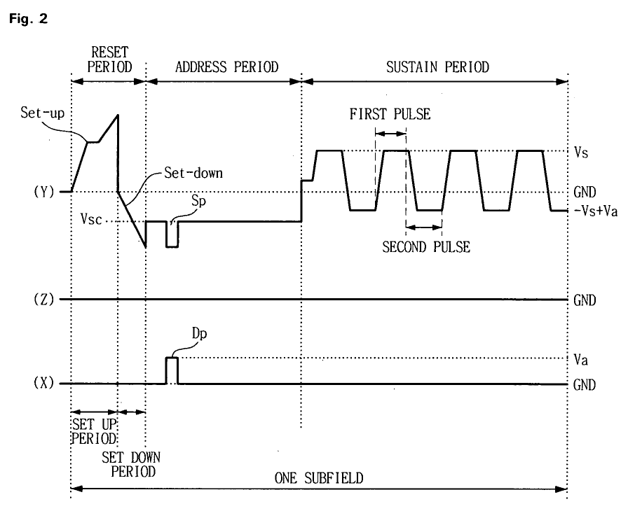

FIG. 2 is a timing diagram illustrating a driving waveform supplied to a plasma display panel according to an embodiment of the present invention.

As shown in FIG. 2, in the method of driving a plasma display apparatus according to the present embodiment, a driving pulse is supplied to each of the electrodes X1 to Xm, Y1 to Yn, and Z1 to Zn by dividing one sub fields into a reset period for initializing the cells of the plasma display panel 50, an address period for selecting cells to discharge, and a sustain period for sustaining the selected cells to discharge in order to display images.

In the reset period or the setup period, a set-up pulse may be supplied to the scan electrodes Y1 to Yn of the plasma display panel 50. The set-up pulse induces a weak discharge in a discharge cell of the plasma display panel. In the set-down period, a set-down pulse falling from a sustain voltage Vs level to a predetermined voltage level may be supplied to the scan electrodes Y1 to Yn. Positive wall charge and negative wall charge can be sufficiently removed from a cell by inducing an erasing discharge between the scan electrodes Y1 to Yn and the address electrode X1 to Xm.

In the address period, a negative scan pulse falling from a scan reference voltage (Vsc) may be supplied to the scan electrodes Y1 to Yn. Furthermore, positive data pulse corresponding to the described scan pulse can be supplied to the address electrodes X1 to Xn. As the voltage difference between the scan pulse and the data pulse is added to the wall voltage generated in the reset period, an address discharge is induced in a discharge cell that receives the data pulse. The wall charge just enough for inducing the discharge is formed at a discharge cell selected by the address discharge when the sustain voltage (Vs) is supplied.

In the sustain period, the first pulse and the second pulse are alternatively supplied to the scan electrodes Y1 to Yn. A predetermined bias voltage may be supplied to the sustain electrodes Z1 to Zn. Preferably, the sustain electrodes Z1 to Zn may sustain a ground level.

By sustaining the sustain electrode to have a predetermined bias voltage as described above, a driving circuit for driving the sustain electrodes can be shortened. Therefore, the manufacturing cost can be reduced.

The first pulse is a pulse that arises from a negative voltage −Vs +Va to a positive sustain voltage Vs and sustains at the positive sustain voltage Vs for a predetermined time. The second pulse is a pulse that falls from the positive sustain voltage Vs to the negative voltage −Vs+Va and sustains at the negative voltage −Vs+Va for a predetermined time.

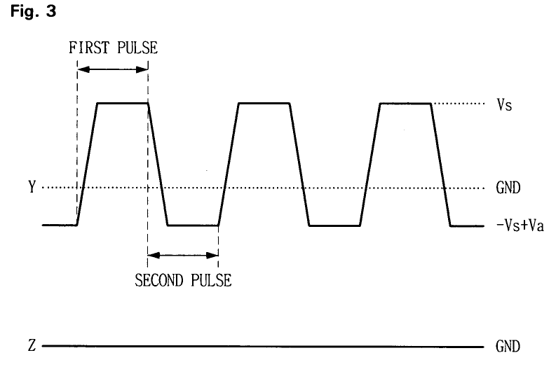

Hereinafter, the first and second pulses will be described in more detail with reference to FIG. 3.

Although it is not shown in the accompanying drawings, an erasing period may be included after the sustain period in order to erase a wall charge after inducing the sustain discharge at a scan electrode or a sustain electrode.

FIG. 3 is a timing diagram illustrating a driving pulse supplied to scan electrodes and sustain electrodes in a sustain period of FIG. 2 according to a first embodiment of the present invention.

Referring to FIG. 3, in the sustain period, the first pulse is supplied to the scan electrode and the second pulse is supplied to the first electrode, alternatively, and the sustain electrode sustains a ground level. In this case, the brightness difference can be corrected by controlling the absolute voltage values of the first and the second pulses to be different.

The absolute voltage values of the first and second pulses can be controlled according to the driving characteristics of the plasma display panel.

Although the absolute voltage value of the first pulse is greater than that of the second pulse in FIG. 3, the absolute voltage value of the second pulse may be greater than that of the first pulse according to the driving characteristics of the plasma display panel.

In this case, the difference between the absolute voltage values of the first and second pulses may be substantially equivalent to the voltage (Va) of a data pulse supplied to the third electrode in the address period.

Also, the difference between the absolute voltage values of the first and second pulses can be controlled within a voltage range of a data pulse supplied to the third electrode in the address period according to the driving characteristics of the plasma display panel. For example, if brightness difference between electrodes is induced in one of subfields while the plasma display panel is driving or if the sustain discharge is unstable, the difference between the voltage absolute values of the first and second pulses is controlled to compensate the instable sustain discharge.

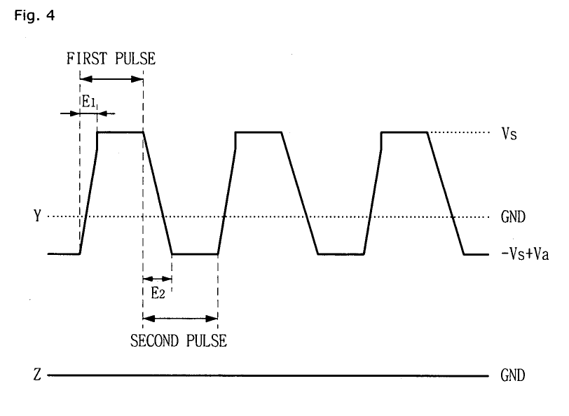

FIG. 4 is a timing diagram illustrating a driving pulse supplied to scan electrodes and sustain electrodes in a sustain period of FIG. 2 according to the second embodiment of the present invention.

As shown in FIG. 4, in the sustain period, the first pulse is supplied to the scan electrode and the second pulse is supplied to the first electrode, alternatively, and the sustain electrodes sustains the ground level. In this case, the raising period E1 of the first pulse that raises from a negative voltage −Vs+Va to a positive sustain voltage Vs is shorter than the falling period E2 of the second pulse that falls from the positive sustain voltage Vs to the negative voltage −Vs+Va.

The raising period of the first pulse can be differently setup according to the driving characteristics of the plasma display panel. The driving characteristic of the plasma display panel, however, can be effectively improved by setting up the raising time of the first pulse longer than 300 ns and shorter than 1 ms.

The ratio between the raising period of the first pulse and the falling period of the second pulse can be differently setup according to the driving characteristics of the plasma display panel. The driving margin of the plasma display panel can be further secured by setting up the ratio between the raising period of the first pulse and the falling period of the second pulse to be larger than 1:1.2 and smaller than 1:1.5.

The raising period E1 or the falling period E2 can be expressed as a slop of a corresponding pulse. That is, it can be expressed as the absolute value of the slop of the first pulse is larger than that of the second pulse.

As described above, the brightness difference between electrode lines can be even further compensated by supplying the first pulse having the raising period E1 shorter than the falling period E2 of the second pulse to the scan electrodes.

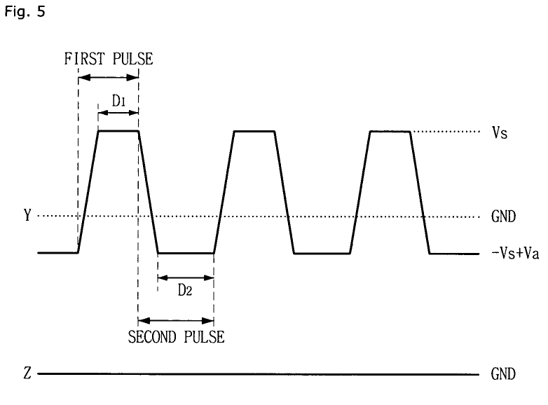

FIG. 5 is a timing diagram illustrating a driving pulse supplied to scan electrode and sustain electrodes in a sustain period of FIG. 2 according to the third embodiment of the present invention.

As shown in FIG. 5, in the sustain period, the first pulse is supplied to the scan electrodes and the second pulse is supplied to the first electrode, alternatively, and the sustain electrodes sustain the ground level. In this case, a first pulse bias period D1 where the first pulse sustains at the positive sustain voltage Vs is shorter than a second pulse bias period D2 where the second pulse sustains at the negative voltage −Vs+Va.

The first pulse bias period D1 can be setup differently according to the driving characteristics of the plasma display panel. The driving characteristic of the plasma display panel, however, can be effectively improved by setting up the first pulse bias period D1 longer than 500 ns and shorter than 2 ms.

Also, the ratio between the first pulse bias period D1 and the second pulse bias period D2 can be differently setup according to the driving characteristics of the plasma display panel. The driving margin of the plasma display panel can be further secured by setting up the ratio between the first pulse bias period and the second pulse bias period to be larger than 1:1.3 and smaller than 1:1.8.

As described above, the brightness difference between electrode lines can be even further compensated by supplying the first pulse having the bias period D1 shorter than the second pulse bias period D2 to the scan electrodes.

In the certain embodiment of the present invention, the first pulse and the second pulse are alternatively supplied to the scan electrodes and the sustain electrodes sustains the ground level in the sustain period. However, it is possible to supply the first pulse and the second pulse to the sustain electrodes and to sustain the scan electrodes at the ground level.

In the certain embodiment of the present invention, the driving pulse is supplied to the scan electrodes the raising time and the falling time of the driving pulse are controlled and supplied to the scan electrodes, and the bias period of the driving pulse is controlled and supplied to the scan electrodes, independently in the sustain period. However, the brightness difference between electrode lines or the driving characteristics of the plasma display panel can be further improved by controlling the raising time, the falling time, and the bias period of the driving pulse at the same time and supplying them to the scan electrodes.

The driving pulse according to the present embodiment can be applied not only to an electrode arrangement, scan electrode-sustain electrode-scan electrode-sustain electrode YZYZ, but also to other electrode arrangements, scan electrode-scan electrode-sustain electrode-sustain electrode YYZZ.

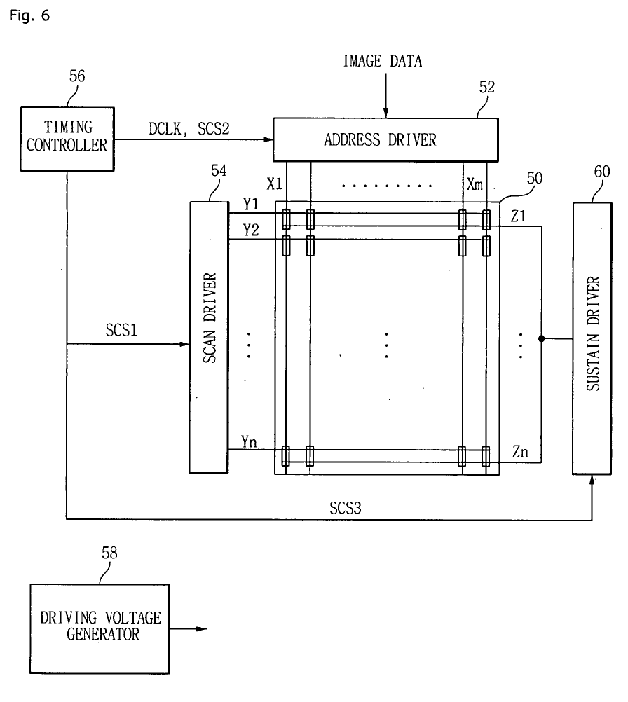

FIG. 6 is a schematic diagram illustrating a plasma display apparatus according to another embodiment of the present invention.

Referring to FIG. 6, the plasma display apparatus according to another embodiment of the present invention comprises a plasma display panel 50, an address driver 52, a scan driver 54, a timing controller 56, and a driving voltage generator 58, which are identical to the plasma display apparatus shown in FIG. 1. Therefore, the descriptions thereof are omitted.

The sustain driver 60 is controlled by a third switching control signal SCS3 supplied from the timing controller 56 and supplies a positive voltage or a negative voltage to sustain electrodes Z1 to Zn.

Hereinafter, a method of driving a plasma display apparatus according to an embodiment of the present invention will be described with reference to the accompanying drawings.

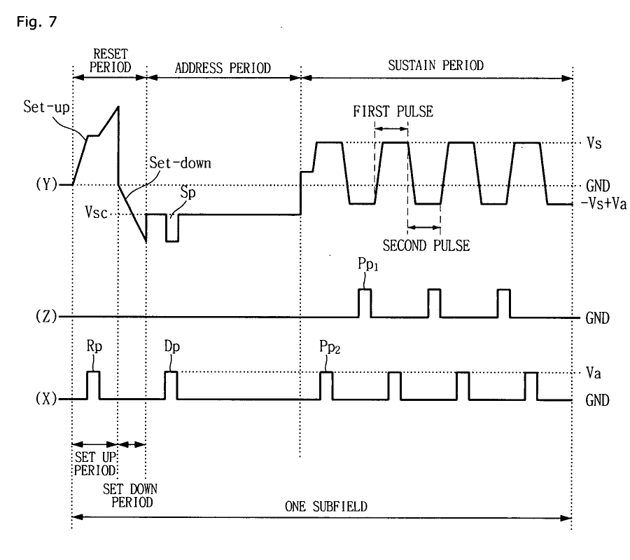

FIG. 7 is a timing diagram illustrating a driving waveform supplied to a plasma display panel according to another embodiment of the present invention.

Referring to FIG. 7, driving waveforms supplied to the plasma display panel according to another embodiment in the reset period and the address period are identical to that shown in FIG. 2. Therefore, the descriptions of the driving waveform supplied in the reset period and the address period are omitted.

On the contrary, a positive bias voltage Rp may be supplied to the address electrodes X1 to Xm in the setup period in the another embodiment of the present invention. The positive bias voltage can further reduce the intensity of the dark discharge generated at the reset period.

In the sustain period, a first pulse and a second pulse having different absolute voltage are alternatively supplied to the scan electrodes, and a first positive pulse Pp1 may be supplied to the sustain electrodes while the second pulse is supplied to the scan electrodes. As a result, a surface discharge between the scan electrodes and the sustain electrodes can be improved, and the brightness difference between the scan electrodes and the sustain electrodes can be further improved. In this case, a second positive pulse Pp2 can be supplied to the address electrodes while the first pulse is supplied to the scan electrodes. The second positive pulse Pp2 can reduce the damage of phosphor due to the wall charge while discharging, and can improve the surface discharge at the same time.

The voltages of the first and second positive pulses supplied to the sustain electrodes and the scan electrodes have about a voltage level not to induce the opposed discharge between the scan electrode and the address electrode. Preferably, the voltages of the first and second positive pulses can be substantially identical to that of the data pulse supplied to the address electrodes. Accordingly, the cost of a driving circuit for driving a plasma display panel can be reduced.

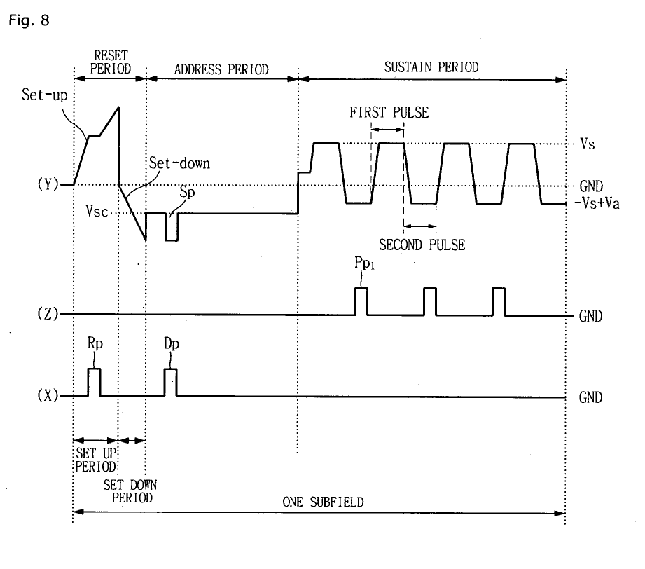

FIG. 8 is a timing diagram illustrating a driving waveform supplied to a plasma display panel according to another embodiment of the present invention.

As shown in FIG. 8, the driving waveform supplied to a plasma display panel according to another embodiment of the present invention is identical to that shown in FIG. 7. Therefore, the description thereof is omitted.

However, the data electrodes sustain as ground in the sustain period.

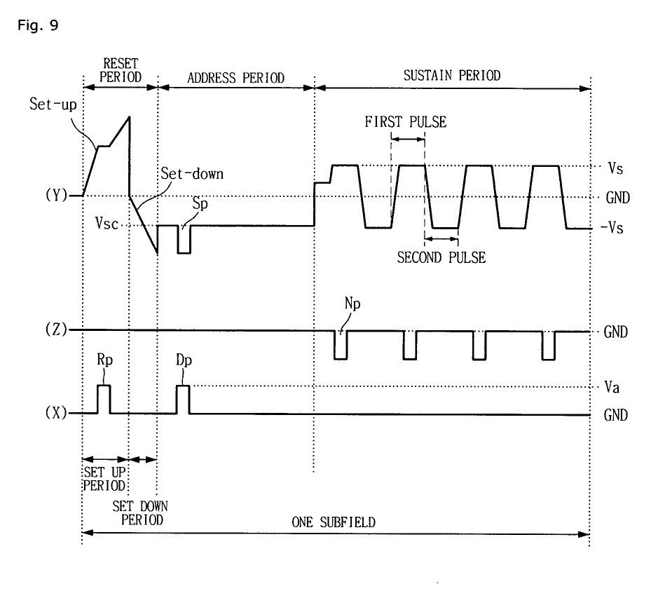

FIG. 9 is a timing diagram illustrating a driving waveform supplied to a plasma display panel according to still another embodiment of the present invention.

As shown in FIG. 9, the driving waveform supplied to the plasma display panel is identical to that shown in FIG. 7. Therefore, the descriptions thereof are omitted.

However, in the sustain period, a first pulse and a second pulse having substantially identical absolute voltage may be alternatively supplied to the scan electrode, and a negative third pulse Np may be supplied to the sustain electrode while the first pulse is supplying to the scan electrode. In this case, the absolute value of the third pulse may be substantially identical to the voltage of the data pulse supplied to the address electrode in the address period.

As described above, the brightness difference between the electrodes can be compensated by the method of driving the plasma display panel according to the present embodiment.

What is claimed is:

1. A method of driving a plasma display apparatus by dividing one subfield into at least an address period and a sustain period, comprising:
alternatively supplying a positive first pulse and a negative second pulse to a first electrode in a sustain period;
sustaining a ground level at a second electrode while the positive first pulse is supplied to the first electrode; and
controlling absolute voltage values of the positive first pulse and the negative second pulse to be different.

2. The method of claim 1, wherein, in the sustain period, the positive first pulse is supplied to the second electrode while the negative second pulse is supplied to the first electrode.

3. The method of claim 2, wherein the second electrode sustains a predetermined voltage for the address period.

4. The method of claim 2, wherein a third electrode sustains a ground level for the sustain period.

5. The method of claim 4, wherein the third electrode sustains a ground level while the negative second pulse is supplied to the first electrode.

6. The method of claim 2, wherein a second positive pulse is supplied to a third electrode while the positive first pulse is supplied to the first electrode.

7. The method of claim 1, wherein an absolute voltage value of the first pulse is greater than an absolute voltage value of the second pulse.

8. The method of claim 1, wherein a difference between absolute voltage values of the first and second pulses is substantially identical to a voltage of a data pulse supplied to a third electrode.

9. The method of claim 1, wherein a raising period of the positive first pulse is shorter than a raising period of the negative second pulse.

10. The method of claim 9, wherein the raising time of the first pulse is longer than about 300 ns and shorter than about 1 ms.

11. The method of claim 9, wherein a ratio of the arising time of the first pulse and a falling time of the second pulse is larger than about 1:1.2 and smaller than about 1:1.5.

12. The method of claim 1, wherein a bias period of the positive first pulse is shorter than a bias period of the negative second pulse.

13. The method of claim 12, wherein the bias period of the first pulse is longer than about 500 ns and shorter than about 2 ms.

14. The method of claim 12, wherein a ratio of the bias period of the first pulse and the bias period of the second pulse is larger than about 1:1.3 and smaller than about 1:1.8.

15. A method of driving a plasma display apparatus by dividing one subfield into at least an address period and a sustain period, comprising:
alternatively supplying a first positive pulse and a second negative pulse having an absolute voltage value smaller than that of the first pulse in the sustain period;
supplying the first positive pulse to a second electrode while the second pulse is supplied to the first electrode; and
supplying a second positive pulse to a third electrode while the first pulse is supplied to the first electrode.

16. The method of claim 15, wherein the second electrode sustains a predetermined voltage for the address period.

17. The method of claim 15, wherein a voltage of the first positive pulse supplied to the second electrode is smaller than a voltage of the second positive pulse supplied to the third electrode.

18. The method of claim 15, wherein the positive bias voltage is supplied to the third electrode in a reset period that is a period precedes the address period.

19. A method of driving a plasma display apparatus by dividing one subfield into at least an address period and a sustain period, comprising:
alternatively supplying a positive first pulse and a negative second pulse having the same absolute voltage value to a first electrode in the sustain period; and
supplying a negative third pulse to a second electrode while the positive first pulse is supplied to the first electrode.

20. The method of claim 19, wherein the absolute voltage value of the third pulse is substantially identical to a voltage of a data pulse supplied to a third electrode in the address period.

21. The method of claim 20, wherein the third electrode sustains a ground level for the sustain period.

22. The method of claim 19, wherein the second electrode sustains a predetermined voltage for the address period.
